(19) United States
(12) Patent Application Publication
(10) Pub. No.: US 2010/0086761 A1
(43) Pub. Date: Apr. 8, 2010

(54) LASER LIGHT TRANSMISSIVE RESIN MEMBER AND RESIN MOLDED PRODUCT MADE THEREOF

(75) Inventor: Hideki OKUDA, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/574,059

(22) Filed: Oct. 6, 2009

(30) Foreign Application Priority Data
Oct. 7, 2008 (JP) 2008-260599

(51) Int. Cl. B32B 27/34; C08G 73/10

(52) U.S. Cl. 428/220; 428/333; 528/310

(57) ABSTRACT

A laser light transmissive resin member for laser-welding includes a laser welding portion adapted to be laser-welded to an external resin component. The laser welding portion is colored so as to display such a color that satisfies the following relations: V≦0.229H+3.714, V≦−0.8H+24, V≧3; and C≦−0.075H²+1.936H+1.267, C≧2. In a Munsell color system, V is value; C is chroma; and H is hue on condition that a hue circle is divided into 100 parts and one of 0 and 100 is assigned to 10 RP of hue. A transmission factor of the laser welding portion when the laser welding portion is irradiated with laser light having a wave length of 800 nm or greater, is equal to or larger than 15%.

### CROSS REFERENCE TO RELATED APPLICATION

This application is based on and incorporates herein by reference Japanese Patent Application No. 2008-260599 filed on Oct. 7, 2008.

### BACKGROUND OF THE INVENTION

1. Field of the Invention

The present invention relates generally to a resin member for laser welding, and more particularly to a resin member having transmission properties with respect to laser light and a resin molded product formed from the resin member.

2. Description of Related Art

Conventionally, a method of joining resin members together by welding them using laser light is known as a method of joining together members formed from resin. According to this method, a laser light transmissive resin member having transmission properties with respect to laser light and a laser light absorbing resin member colored dark such as black and having absorption properties with respect to laser light are placed in contact with each other, and they are irradiated with laser light from a side of the laser light transmissive resin member. Accordingly, the laser light which has passed through the laser light transmissive resin member is absorbed in the laser light absorbing resin member so as to generate heat, and the vicinity of a contact surface between both the members melts. When the irradiation of laser light is stopped in this state, the melted places in both the members fall in temperature so as to become solidified. As a result, a resin molded product with both the members welded together is obtained.

A member made of resin is sometimes discolored over time in some usage environments. For example, a colorless resin member formed from polyamide resin is sometimes easily discolored in a color range of yellow to brown when used in the high temperature environment, so that its appearance may seriously deteriorate. For this reason, according to the technology described in JP-T-2003-517075 (corresponding to US2003/0125429A1), the discoloration of the laser light transmissive resin member is concealed by coloring beforehand the laser light transmissive resin member dark (Y<30, Y<20, or Y<10) such that a Y value (value) of standard color valency is small.

Impure substances such as carbon dust are sometimes mixed into the member formed from resin in its manufacturing process. When laser welding is carried out using a laser light transmissive resin member including such impure substances, the impure substance absorbs energy of laser light so as to generate heat. Accordingly, a surrounding area of the impure substance is carbonized and thereby a black dot is produced on the surface of the laser light transmissive resin member or inside the resin member. When the black dot is generated in the laser light transmissive resin member, a part of the laser light is blocked off by the black dot, so that the energy of laser light does not sufficiently reach the laser light absorbing resin member. As a result, insufficient welding between both members is caused. Therefore, by identifying the number of generated black dots or a size of the black dot, for example, after the laser welding, whether both members are sufficiently welded is determined.

When the laser light transmissive resin member and the laser light absorbing resin member are placed in contact with each other so as to form a volume chamber between both the members, and high air-tightness or liquid-tightness is required for this volume chamber, for example, both members need to be welded sufficiently and air-tightly or liquid-tightly on their contact surface. For that reason, it is important to determine whether both members are sufficiently welded by verifying a generation status of the black dot after the laser welding.

However, as described above, the laser light transmissive resin member disclosed in JP-T-2003-517075 is colored dark, i.e., low value. Thus, it is difficult to verify the generation status of the black dot after the laser welding. Accordingly, when such a laser light transmissive resin member is used for laser welding, it is difficult to detect a resin molded product, which is not sufficiently welded, as a defective product.

### SUMMARY OF THE INVENTION

The present invention addresses the above disadvantages. Thus, it is an objective of the present invention to provide a laser light transmissive resin member which has good appearance and conceals discoloration over time and which results in easy determination of failure or no-failure of a welding state after laser welding.

To achieve the objective of the present invention, there is provided a laser light transmissive resin member for laser-welding, including a laser welding portion. The laser welding portion is adapted to be laser-welded to an external resin component. The laser welding portion is colored so as to display such a color that satisfies the following relations: V≦0.229H+3.714, V≦−0.8H+24, V≧3; and C≦−0.075H²+1.936H+1.267, C≧2. In a Munsell color system, V is value; C is chroma; and H is hue on condition that a hue circle is divided into 100 parts and one of 0 and 100 is assigned to 10 RP of hue. A transmission factor of the laser welding portion when the laser welding portion is irradiated with laser light having a wave length of 800 nm or greater, is equal to or larger than 15%.

To achieve the objective of the present invention, there is also provided a resin molded product including the laser light transmissive resin member and a laser light absorbing resin member. The laser light absorbing resin member includes a laser absorbing portion which absorbs a laser light having a predetermined wave length that has passed through the laser welding portion so as to generate heat. The laser absorbing portion has a contact surface that is in contact with the laser welding portion of the laser light transmissive resin member. The laser light absorbing resin member is welded to the laser light transmissive resin member at the contact surface as a result of the heat generation of the laser absorbing portion.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view illustrating an example of application of a laser light transmissive resin member to a fluid control valve in accordance with an embodiment of the invention;

FIG. 2 is a diagram illustrating arrangement of the fluid control valve, to which the laser light transmissive resin member is applied, in an inlet system of an internal combustion engine in accordance with the embodiment;

FIG. 3 is a diagram illustrating a hue range of colors in which the laser light transmissive resin member in accordance with the embodiment is colored in a hue circle of Munsell color system;

FIG. 4 is a diagram illustrating a range of colors with which the laser light transmissive resin member in accordance with the embodiment can be tinted in a relationship between value and hue;

FIG. 5 is a diagram illustrating a range of colors with which the laser light transmissive resin member in accordance with the embodiment can be tinted in a relationship between chroma and hue;

FIG. 6 is a diagram illustrating a range of colors with which the laser light transmissive resin member in accordance with the embodiment can be tinted in a constant hue color chart of Munsell color system;

FIG. 7A is a sectional view illustrating that the laser light transmissive resin member in accordance with the embodiment is laser-welded normally to a laser light absorbing resin member; and

FIG. 7B is a sectional view illustrating that the laser light transmissive resin member in accordance with the embodiment is laser-welded to the laser light absorbing resin member, when a black dot is generated in the laser light transmissive resin member.

### DETAILED DESCRIPTION OF THE INVENTION

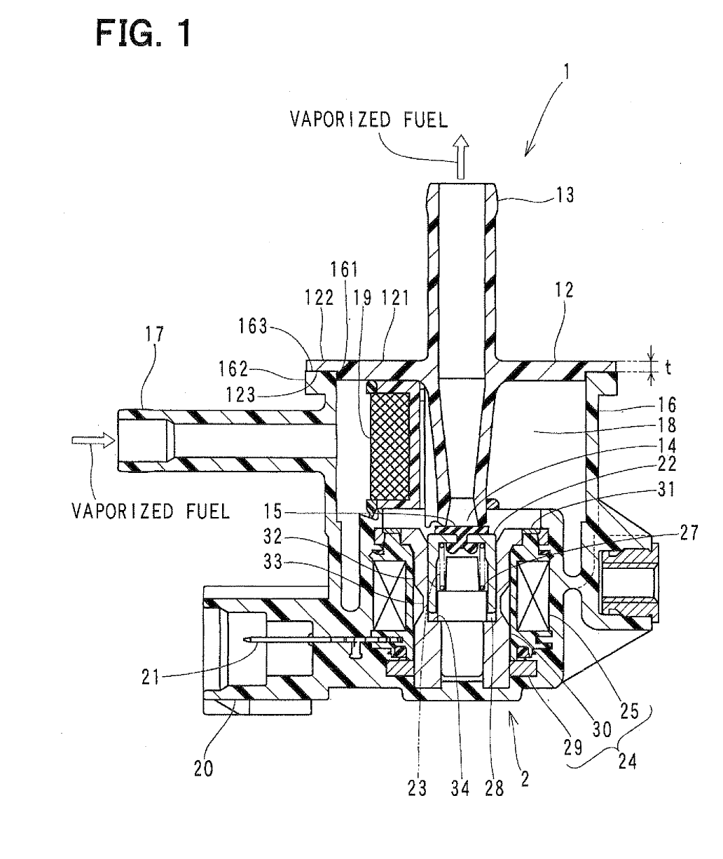

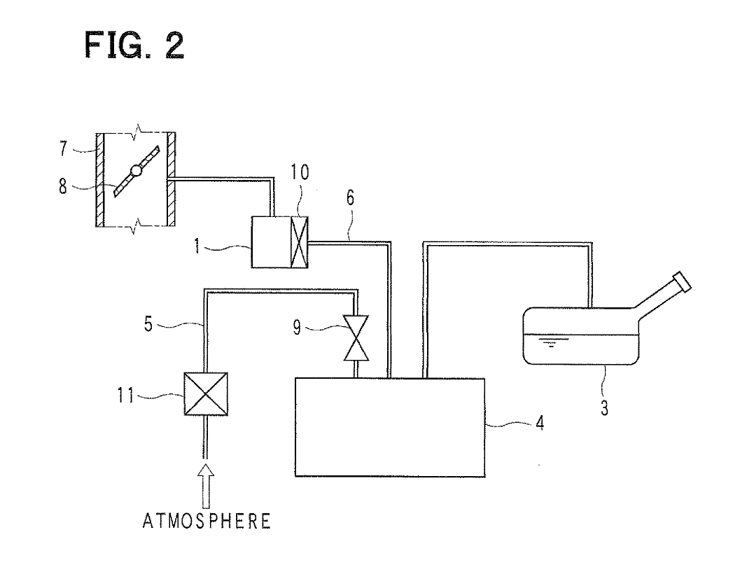

An embodiment of the invention is described below with reference to the accompanying drawings. An application of a laser light transmissive resin member according to the embodiment as an outlet passage cap to a purge valve as a resin molded product is illustrated in FIG. 1. As shown in FIG. 2, a canister 4 which adsorbs and holds fuel vaporized in a fuel tank 3 is provided in a vehicle. This canister 4 is provided so as to lead atmospheric air through an atmospheric air introducing passage 5. The canister 4 is connected to a downstream side of a throttle valve 8 in an intake pipe 7 which is a negative pressure generating portion via a purge passage 6. Air is introduced into the canister 4 through a filter 11 from the outside by opening a valve 9 in the introducing passage 5 when an engine is in operation, and vaporized fuel held in the canister 4 is conducted to the intake pipe 7 through a filter 10 by opening a purge valve 1 in the purge passage 6.

The purge valve 1 is explained with reference to FIG. 1. The purge valve 1 is a normally-closed electromagnetic valve which communicates between upstream and downstream sides of the purge passage 6 upon energization, and functions as a fluid control valve. In the description of the purge valve 1 below, explanation is given, for convenience, with an outflow port 13 side of FIG. 1 as an upper side and with an electromagnetic actuator 2 side of FIG. 1 as a lower side. The purge valve 1 includes an outlet passage cap 12 having the outflow port 13 connected to an intake pipe 7 side of the purge passage 6, a valve body 15 which opens and closes a valve port 14 leading to the outflow port 13, and the electromagnetic actuator 2 which is covered in a housing 16 having an inflow port 17 connected to a canister 4 side of the purge passage 6 and which drives the valve body 15 to open and close the valve port 14.

A chamber 18 as a space serving as a volume chamber, which communicates with the inflow port 17, is formed between the outlet passage cap 12 and the housing 16. The outlet passage cap 12, the housing 16, and the joining between the outlet passage cap 12 and the housing 16 are hereinafter described in detail. The valve port 14 which is an end portion of the outflow port 13 formed to extend into the chamber 18 is opened and closed by the valve body 15 made of rubber and attached to a moving core 22 as a movable part of the electromagnetic actuator 2. More specifically, a lower part of the outflow port 13 is the valve port 14, and communication of the purge passage 6 is closed as a result of engagement of the valve body 15 with the valve port 14, whereas the purge passage 6 communicates through the purge valve 1 as a result of disengagement of the valve body 15 from the valve port 14.

A filter 19 is attached inside the chamber 18, and vaporized fuel, which has flowed into the chamber 18 through the inflow port 17, is guided to the valve port 14 through the filter 19. The electromagnetic actuator 2 includes a return spring 23 which urges the moving core 22 in a direction in which the valve body 15 engages the valve port 14, and a solenoid 24 which magnetically attracts the moving core 22 in a valve opening direction against urging force of the return spring 23, in addition to the moving core 22 on which the valve body 15 is attached.

The moving core 22 is a cup-shaped movable part with the valve body 15 attached on its upper end, and made of magnetic material metal such as iron. The return spring 23 is a compression coil spring which urges the moving core 22 in a valve closing direction, and its one end is in contact with the moving core 22, whereas its other end is in contact with a spring holding part 27 in the moving core 22.

When a lift amount of the valve body 15 reaches a predetermined amount, an upper end portion of the spring holding part 27 comes into contact with the valve body 15 inserted in the moving core 22, so that the spring holding part 27 determines a maximum lift amount of the valve body 15. The solenoid 24 includes a coil 25, a yoke 29, and a stator 30, and its energization is controlled by a connector 20. These are resin-molded by postformation which makes the housing 16 of the solenoid 24.

The stator 30 has a generally cylindrical shape and is made of magnetic material metal such as iron. A lower part of the stator 30 is fitted to a lower part of the yoke 29, and a magnetic ring 31 is fitted through an upper part of the yoke 29. A magnetic attraction gap 28 is formed between an attraction part 34 and the moving core 22 in their axial direction. The yoke 29 is formed from magnetic metal such as iron. The yoke 29 is formed in a generally U-shape as a result of cutting an opposing part out of a side wall of a member formed in a cup shape. The yoke 29 is disposed such that its side wall is located on an outer circumferential side of the coil 25. A side wall of the yoke 29 is connected to an upper part of the stator 30 via the magnetic ring 31, and a lower part, i.e., a bottom wall of the yoke 29 is connected to the lower part of the stator 30.

The coil 25 is prepared as a result of winding many times a conductive wire made of, for example, an enameled wire to which an insulating coating is applied, around a cylindrically-shaped bobbin of primary formation resin having a flange at its both end portions. The coil 25 generates magnetic force when energized so as to form a magnetic flux loop passing through the moving core 22, the yoke 29, and the stator 30. The connector 20 is a connecting means for electrically connecting the purge valve 1 to an electronic control unit (not shown) for controlling the purge valve 1 to open and close via a contact line. Connector terminals 21, which are connected respectively to both ends of the coil 25, are disposed inside the connector 20. This connector terminal 21 is resin-molded by postformation which makes the housing 16, and its one end is inserted into the bobbin, whereas its other end is exposed inside the connector 20.

The electronic control unit includes a purge fuel calculating means for calculating concentration of vaporized fuel held in the canister 4 and for calculating purge fuel led into the intake pipe 7 when the purge valve 1 is opened by calculating a flow through the purge passage 6 when the purge valve 1 is opened based on an engine operational state. The electronic control unit is set so as to keep an air/fuel ratio at a target air/fuel ratio suitable for the engine operational state by correcting injection quantity of fuel injected from an injector when the purge valve 1 is opened.

As shown in FIG. 1, the stator 30 includes an accommodating part 32 which covers an outer circumferential surface of the moving core 22 so as to slidably hold the moving core 22 in its axial direction, the magnetic ring 31 formed in a flanged shape and disposed around an upper part of the accommodating part 32, an attracting part 34 which attracts the moving core 22 to one side of the axial direction, and a magnetism reduced portion 33 which is cylindrically formed between the accommodating part 32 and the attracting part 34 and which has smaller wall thickness than the accommodating part 32. They are formed integrally into the stator 30.

The outlet passage cap 12, the housing 16, and the joining between the outlet passage cap 12 and the housing 16 are described below in detail. The outlet passage cap 12 is formed from, for example, resin of a polyamide system having thermoplasticity. As shown in FIG. 1, the outlet passage cap 12 has a covering part 121 which expands in a plate-shaped manner radially outward of the outflow port 13 having a generally cylindrical shape. An outer edge part of the covering part 121 is formed as a welded portion 122 which is a part laser-welded to the housing 16. The welded portion 122 is formed so as to have a thickness T. In the present embodiment, T is set at 2.5 mm. The welded portion 122 has a contact surface 123 in contact with the housing 16.

The housing 16 is formed from, for example, resin of a polyamide system having thermoplasticity similar to the outlet passage cap 12. The housing 16 has an opening 161 at its end portion on the opposite side from the electromagnetic actuator 2. The housing 16 has a welded portion 162 which is a part laser-welded onto the outlet passage cap 12 on an outer circumferential side of the opening 161. The welded portion 162 has a contact surface 163 in contact with the contact surface 123 of the covering part 121. Because of the above-described constitution, the covering part 121 closes the opening 161 of the housing 16 as a result of the contact of the contact surface 123 with the contact surface 163. The contact surface 123 and the contact surface 163 are welded together by laser welding.

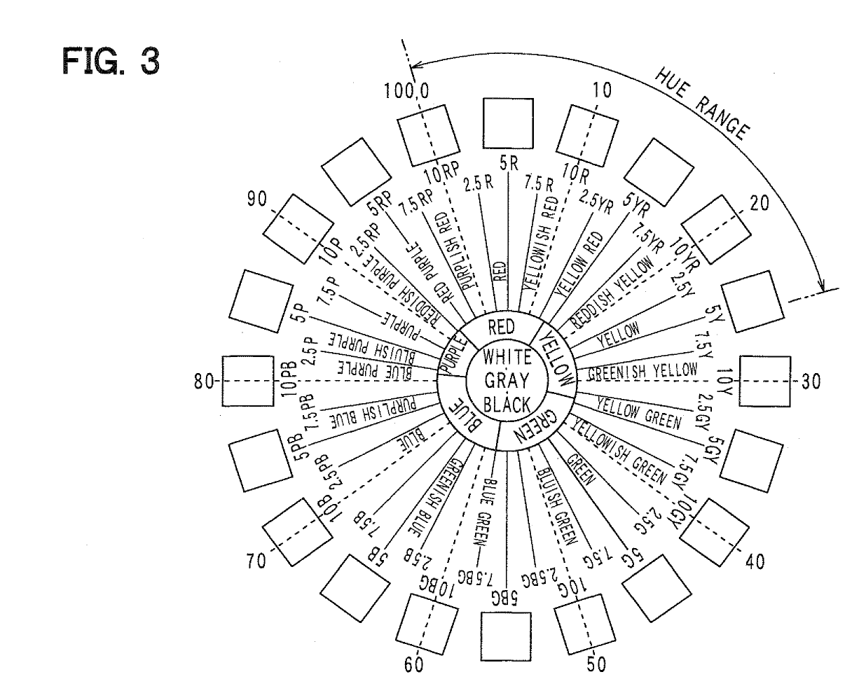

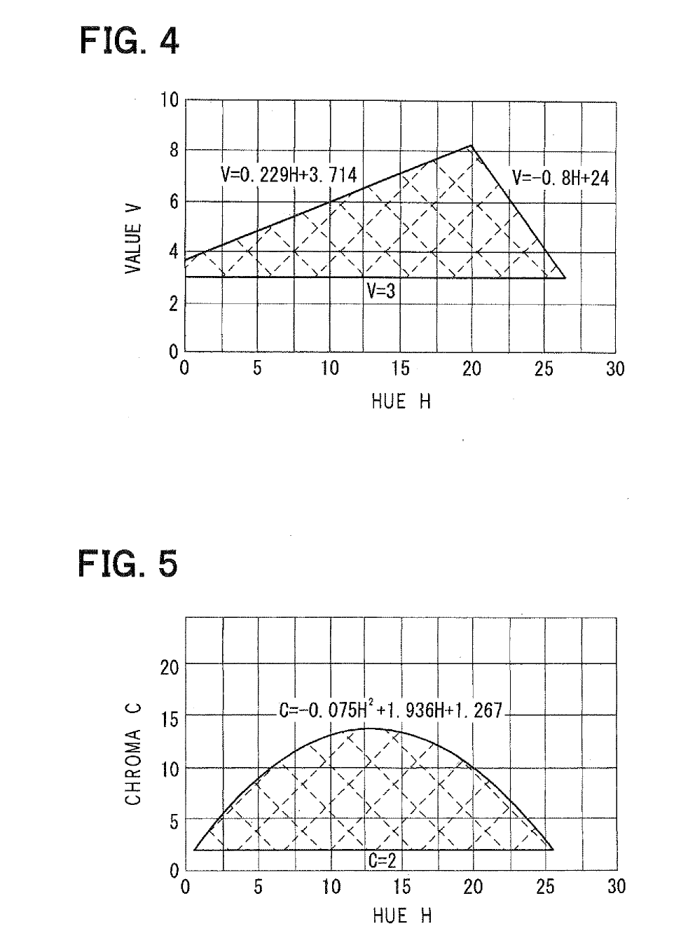

The outlet passage cap 12 is colored so as to display a color that satisfies relations of “V≦0.229H+3.714, V≦−0.8H+24, V≧3 (see FIG. 4)” and “C≦−0.075H²+1.936H+1.267, C≧2 (see FIG. 5)” given that value is V, chroma is C, and hue when a hue circle is divided into 100 parts and hue 10RP is ‘0’ or ‘100’ is H in a Munsell color system (Japanese Industrial Standards Z8721; see FIG. 3), by forming resin of a polyamide system into the cap 12 with a colorant included in the resin, for example.

A color that satisfies the above relations is described below in detail. FIG. 3 illustrates a hue circle in the Munsell color system colorlessly for convenience. A value of hue (H) when the hue circle is divided into 100 parts and hue 10RP is ‘0’ or ‘100’ is indicated in FIG. 3. For example, in this case, hue (H) 10, 20, 30, 40, 50, 60, 70, 80, 90 corresponds respectively to hue 10R, 10YR, 10Y, 10GY, 10G, 10BG, 10B, 10PB, 10P in the Munsell color system.

FIG. 4 illustrates a range of colors with which the outlet passage cap 12 can be tinted by an area bounded by the relational expressions “V≦0.229H+3.714, V≦−0.8H+24, V≧3” expressing a relationship between H and V (region shaded with a grid-like short dashed line) with hue (H) along a horizontal axis and with value (V) along a vertical axis. FIG. 5 illustrates a range of colors with which the outlet passage cap 12 can be tinted by an area bounded by the relational expressions “C≦−0.075H²+1.936H+1.267, C≧2” expressing a relationship between H and C (region shaded with a grid-like short dashed line) with hue (H) along a horizontal axis and with chroma (C) along a vertical axis.

Therefore, the outlet passage cap 12 is tinted with a color that displays a hue (H) included in both of the region shown by shading in FIG. 4 and the region shown by shading in FIG. 5. The hue of the color that satisfies the relations of “V≦0.229H+3.714, V≦−0.8H+24, V≧3” and “C≦−0.075H²+1.936H+1.267, C≧2” is included generally in a range of hue 10 RP to 5Y as shown in FIG. 3. The color that satisfies the above relations visually displays a brownish color in a range of red brown to yellow brown.

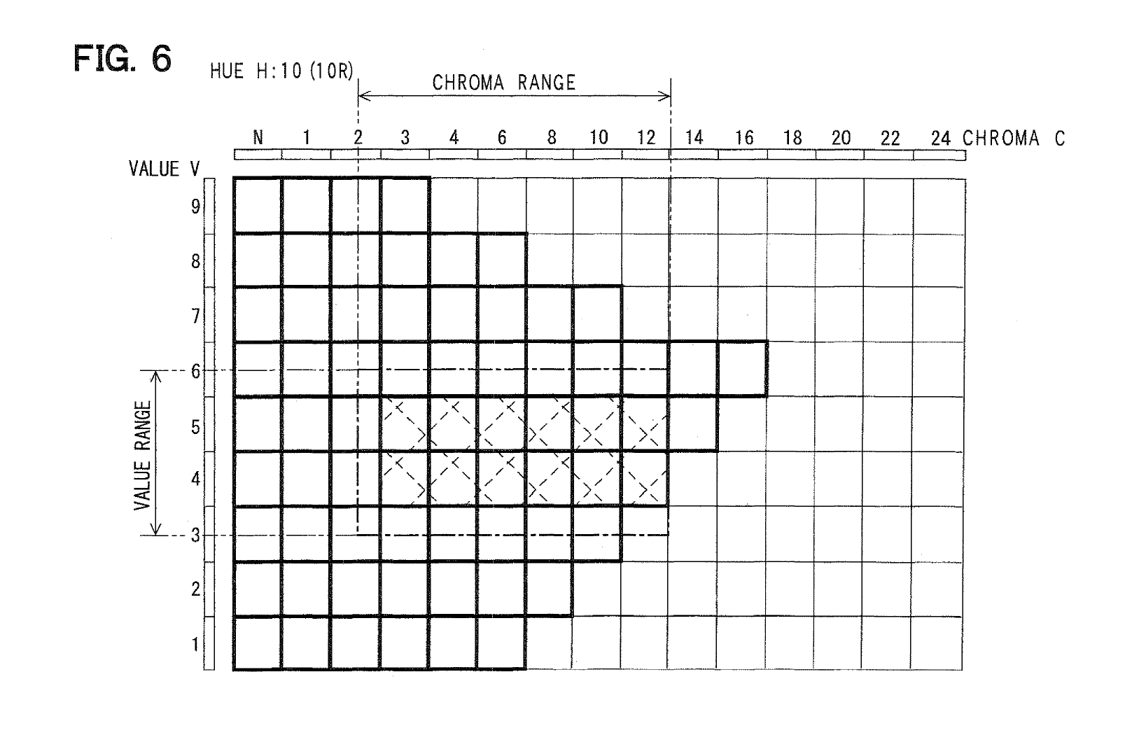

For example, a range of colors with which the outlet passage cap 12 of the present embodiment can be tinted with regard to a specific hue is illustrated in FIG. 6. FIG. 6 illustrates a constant hue color chart with hue 10R (hue (H) 10) in the Munsell color system. FIG. 6 is not colored for convenience. In an actual constant hue color chart, each square surrounded by a thick continuous line in FIG. 6 is colored. In an actual constant hue color chart, each square is tinted with a color having the same hue with a value scale along its vertical axis and a chroma scale along its horizontal axis.

When the color with which the outlet passage cap 12 of the present embodiment is tinted is hue 10R (hue (H) 10) and satisfies the above relations, the colors with which the outlet passage cap 12 can be tinted fall within a range of 3≦V (value) ≦6.004 (see FIG. 4) and 2≦C (chroma) ≦13.127 (see FIG. 5) when H(hue)=10, from the expressions “V≦0.229×10+3.714, V≦−0.8×10+24, V≧3” and “C≦−0.075×10²+1.936×10+1.267, C≧2.” This range is indicated by an area enclosed by an alternate long and short dash line in FIG. 6. Accordingly, in the constant hue color chart with hue 10R (hue (H) 10), the outlet passage cap 12 can be tinted with colors corresponding to blocks (squares shaded with a grid-like short dashed line) within the area enclosed by an alternate long and short dash line in FIG. 6. Colors of these blocks are displayed visually as brown in an actual constant hue color chart.

In addition, in reality, a color without a scale exists in relation to value and chroma. Therefore, if a color satisfies the above relations (area enclosed by an alternate long and short dash line in FIG. 6), such a color may be included in the colors with which the outlet passage cap 12 of the present embodiment can be tinted, in addition to colors of the above squares shaded with a grid-like short dashed line. Whether a color of the outlet passage cap 12 is a color that satisfies the above relations may be determined by measuring the color of the outlet passage cap 12 using a colorimeter or a spectrocolorimeter, for example, under predetermined conditions, such as a state in which the outlet passage cap 12 is illuminated with visible light (for example, CIE/ISO base light (color temperature 6504K)). Because a color of an object is identified by, for example, measuring reflection of light from a certain light source, a state in which the outlet passage cap 12 is illuminated with, for example, sunlight or, an indoor fluorescent lamp or an indoor incandescent lamp may also be taken into account as the above described predetermined conditions.

The welded portion 122 of the outlet passage cap 12 indicates a transmission factor of 15% or higher with respect to the laser light having a wave length of 800 nm or longer with the welded portion 122 colored as above. Accordingly, laser welding is carried out using the laser light having a wave length of 800 nm or longer. More specifically, when the welded portion 122 is irradiated with the laser light having a wave length of 800 nm or longer from the opposite side of the welded portion 122 from the contact surface 123 and the laser light is transmitted toward the contact surface 123, energy of the laser light after transmission is 15% or higher provided that the energy of the laser light before transmission is 100%. It follows that the outlet passage cap 12 is formed from laser light transmissive resin through which a laser light having a predetermined wave length is transmitted. Thus, the outlet passage cap 12 is formed as a “laser light transmissive resin member.”

On the other hand, the housing 16 is colored dark, such as black having low value and low chroma by forming the housing 16 with, for example, a colorant included in resin of a polyamide system. Accordingly, the housing 16 absorbs a predetermined laser light. It follows that the housing 16 is formed from laser light absorbing resin. Thus, the housing 16 is formed as a “laser light absorbing resin member.”

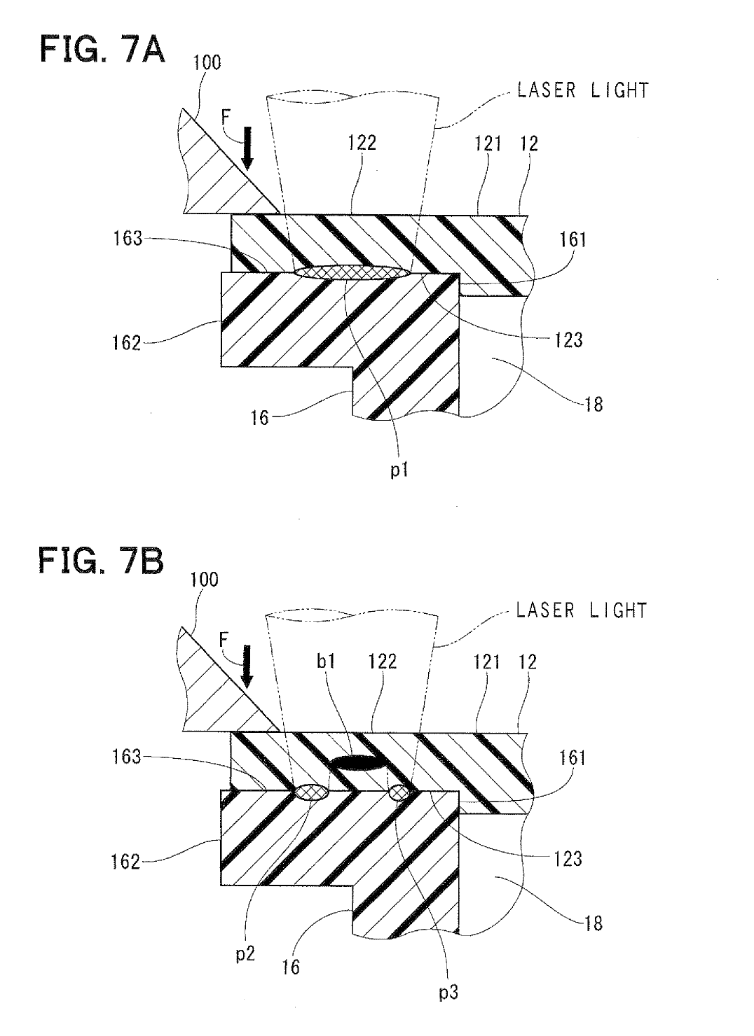

Next, the joining between the outlet passage cap 12 and the housing 16 by laser welding is described below with reference to FIG. 7A and FIG. 7B. In laser welding the outlet passage cap 12 and the housing 16 together as shown in FIG. 7A, the contact surface 123 of the outlet passage cap 12 and the contact surface 163 of the housing 16 are first brought into contact with each other. Secondly, a predetermined pressure F is applied to the welded portion 122 of the outlet passage cap 12 by a pressurizing means 100 so as to closely attach the contact surface 123 on the contact surface 163. Then, in this state, the outlet passage cap 12 is irradiated with laser light from the opposite side of the welded portion 122 from the contact surface 123. As a result, the laser light passes through the welded portion 122 and is absorbed by the welded portion 162 (contact surface 163) of the housing 16. The welded portion 162 generates heat upon absorbing the laser light on the contact surface 163. Due to this heat generation, the welded portion 162 and the welded portion 122 melt on the contact surface 163 (contact surface 123), and both the melted resins are mixed together, so that a melt pool p1 (indicated by grid-like hatching in FIG. 7A) is formed. When the irradiation of laser light is stopped or a radiation position of the laser light is displaced, the melted part (melt pool p1) of the welded portion 162 and the welded portion 122 falls in temperature and solidifies. Accordingly, the welded portion 122 and the welded portion 162 are welded together at the melt pool p1. By carrying out the irradiation of laser light along the whole circumference (welded portion 122) of the outer edge part of the covering part 12 in the above-described manner 1, the outlet passage cap 12 and the housing 16 are finally air-tightly or liquid-tightly welded and joined together.

A laser diode that generates infrared light having a wave length of 808 nm to 940 nm, an yttrium aluminum garnet (YAG) laser that generates infrared light having a wave length of 1064 nm, or a carbon dioxide (CO2) laser that generates infrared light having a wave length of 10600 nm, for example, may be suitably selected out as a laser light used in the above laser welding. In addition, when resin members are laser-welded together as in the present embodiment, a laser diode may be used from the viewpoint of beam quality (heat source), cost, profitability, and efficiency, for example.

Impure substances such as carbon dust are sometimes mixed into a member which is formed from resin in its manufacturing process. A phenomenon that can emerge if such impure substances are included in the outlet passage cap 12 is described below with reference to FIG. 78. In the case where the outlet passage cap 12 is irradiated with laser light from the opposite side of the welded portion 122 from the contact surface 123, if an impure substance is included in an irradiation area, this impure substance absorbs energy of the laser light so as to generate heat. Resin around the impure substance is carbonized due to the heat generated in the above-described manner, so that a black dot b1 (oval figure daubed with black in FIG. 7B) is produced. Since a part of the laser light is blocked by the black dot b1, there emerges a spot that the energy of the laser light does not reach sufficiently, partly on the contact surface 163 of the welded portion 162. Consequently, a portion which is not sufficiently welded is produced between a melt pool p2 and a melt pool p3 in the welded portion 122 and the welded portion 162. As a result, a purge valve in which the outlet passage cap 12 and the housing 16 are not sufficiently welded together is completed.

However, the outlet passage cap 12 of the present embodiment is, as described above, tinted with a color whose value V is 3 or more and whose chroma C is 2 or more. Accordingly, even if a black dot whose value and chroma are low is produced on a surface of or inside the welded portion 122 of the outlet passage cap 12, the black dot is easily discovered and a generation status of the black dot is verified with ease. Therefore, failure or no-failure of a welding state of the outlet passage cap 12 after laser welding is determined without difficulty. In addition, when a resin molded product is made of the laser light transmissive resin member of the invention through the laser-welding and the resin molded product is produced as a product, a resin molded product, which is not sufficiently welded, is easily detected as a defective product. Because of this, a defective product is readily excluded from the products manufactured, so that the market can be stably supplied with a high-quality product. As a result, a purge valve whose members are insufficiently welded together is readily excluded as a defective product.

A basic operation of the purge valve 1 having the above-described constitution is explained below with reference to FIG. 1 and FIG. 2. When the coil 25 of the electromagnetic actuator 2 is energized by the electronic control unit, so that the purge valve 1 is turned on, a magnetic flux is generated in the coil 25. This magnetic flux passes through a magnetic circuit constituted of the magnetic ring 31, the accommodating part 32, the magnetism reduced portion 33, the moving core 22, the attracting part 34, and the yoke 29, so as to form a magnetic flux loop. The magnetic flux flowing from the magnetic ring 31 side to the attracting part 34 side of the accommodating part 32 is compressed and the resistance thereto becomes great, because a wall thickness of the magnetism reduced portion 33 is small and a magnetic path area is small.

When the magnetic flux passing through the magnetism reduced portion 33 is saturated, the magnetic flux is released between the moving core 22 and the attracting parts 34. The magnetic flux flows between the moving core 22 and the attracting parts 34, so that a strong magnetic field is generated in the magnetic attraction gap 28. The moving core 22 is magnetically attracted to the attracting part 34 against the urging force of the return spring 23 so as to be displaced in a valve opening direction, i.e., toward the lower side of FIG. 1. As a result, the valve body 15 attached on the moving core 22 also moves in the valve opening direction, so that the valve body 15 opens the valve port 14. Accordingly, the inflow port 17 and the outflow port 13 communicate through the valve port 14 in the chamber 18, and thus the purge passage 6 is opened. For this reason, the vaporized fuel held by the canister 4 is suctioned into the intake pipe 7 by the negative pressure of intake air.

When the purge valve 1 is turned off by the electronic control unit, the magnetic flux generated in the coil 25 no longer exists. Therefore, the moving core 22 is displaced in a valve closing direction by the urging force of the return spring 23. As a result, the valve body 15 attached on the moving core 22 also moves in the valve closing direction so as to close the valve port 14. Accordingly, the communication between the inflow port 17 and the outflow port 13 is closed in the chamber 18, and thus the purge passage 6 is closed. In consequence, the vaporized fuel held by the canister 4 is not suctioned into the intake pipe 7. Additionally, since the purge valve 1 operates in the above-described manner, high airtightness is required for the chamber 18 through which vaporized fuel flows.

In the present embodiment, as has been described above, the outlet passage cap 12 as a laser light transmissive resin member is colored so as to display a color that satisfies the relations of “V≦0.229H+3.714, V≦−0.8H+24, V≧3” and “C≦−0.075H²+1.936H+1.267, C≧2.” In other words, the outlet passage cap 12 is tinted with a brownish color that presents value and chroma having a predetermined value or above. Because of this, appearance of the outlet passage cap 12 is improved. Furthermore, because the outlet passage cap 12 is colored brownish in its initial state, even if the outlet passage cap 12 is discolored over time, this discoloration is concealed. Therefore, satisfactory good appearance is maintained during use or after use of the laser light transmissive resin member.

The outlet passage cap 12 is, as described above, colored with a color having value (V) of 3 or more and chroma (C) of 2 or more. Accordingly, even if a black dot whose value and chroma are low is produced on a surface of or inside the outlet passage cap 12, the black dot is easily discovered and a generation status of the black dot is verified with ease. Therefore, failure or no-failure of a welding state of the outlet passage cap 12 after laser welding is determined without difficulty.

The purge valve 1 according to the present embodiment is a resin molded product obtained as a result of joining the outlet passage cap 12 and the housing 16 together by laser welding. Thus, by verifying the generation status of the black dot produced in the outlet passage cap 12, a purge valve in which the outlet passage cap 12 and the housing 16 are not sufficiently welded together is easily detected as a defective product. As a result, the purge valve that is condemned as a defective product is eliminated with ease, and the market is stably supplied with a high-quality purge valve.

Moreover, in the present embodiment, the outlet passage cap 12 is formed from resin of a polyamide system. The resin of a polyamide system is easily discolored with a color in a range of yellow to brown. The outlet passage cap 12 is colored brownish in its initial state. Accordingly, even if the outlet passage cap 12 is discolored with a color in a range of yellow to brown over time, the discoloration is effectively concealed. In the present embodiment, an effect of concealing discoloration is further enhanced because the outlet passage cap 12 is formed from resin of a polyamide system.

In addition, in the present embodiment, a thickness of the welded portion 122 as a laser-welded region of the outlet passage cap 12 is set at 2.5 mm. Accordingly, even if a black dot is generated inside the welded portion 122, the black dot is found more easily. In a purge valve as in the present embodiment, high airtightness is required for the internal space (volume chamber) in view of its use as a product. In the present embodiment, the outlet passage cap 12 is used as a laser light transmissive resin member and laser-welded to the housing 16. As a result, the outlet passage cap 12 defines the chamber 18 as a volume chamber between the cap 12 and the housing 16. Since the outlet passage cap 12 has the above-described characteristics, a welding state after it is laser-welded to the housing 16, i.e., whether the welding is sufficiently performed is easily determined. Consequently, only the purge valve 1 in which the outlet passage cap 12 and the housing 16 are sufficiently and airtightly welded together is easily made a product or the like. Therefore, even when high airtightness is required for the chamber 18 formed in the purge valve 1, this requirement is satisfied.

Since the resin molded product of the invention is made from the laser light transmissive resin member, it produces a similar effect to the laser light transmissive resin member. More specifically, the laser light absorbing resin member, which is formed into the resin molded product, has good appearance, and even if it is discolored over time, this discoloration is concealed. Furthermore, by use of the laser light absorbing resin member, failure or no-failure of a welding state is easily determined after laser welding. Thus, when the resin molded product of the invention is manufactured as finished goods, a defective product is readily excluded from the products manufactured, so that the market can be stably supplied with a high-quality product.

### Other Embodiments

An outlet passage cap as a laser light transmissive resin member may be formed from polyester series resin such as polyethylene terephthalate (PET) or polybutylene terephthalate (PBT), or resin having thermoplasticity such as polyphenylene sulfide resin (PPS), instead of resin of a polyamide system. In the invention, the outlet passage cap is colored brownish in the initial state. Thus, even if the outlet passage cap is formed from the resin enumerated above, and discolored over time, this discoloration is concealed. Even if the laser light transmissive resin member is used, for example, in the high temperature environment, and is thereby discolored over time with a color in a range of yellow to brown, this discoloration is effectively concealed. Therefore, according to the invention, when the laser light transmissive resin member is formed from polyamide resin, an effect of concealing the discoloration is further heightened.

Furthermore, a housing as a laser light absorbing resin member may be formed not only from resin of a polyamide system, but also from the resin enumerated above. The housing may be formed from a different type of resin instead of resin that is the same in type as the resin from which the outlet passage cap is formed if it is capable of being laser-welded to the outlet passage cap.

Moreover, a thickness of a welded portion of the outlet passage cap may be set at any thickness in a range of 2.5 mm or less. The outlet passage cap may be colored through the application of a colorant to its surface instead of by coloring the outlet passage cap through its formation with a colorant included in resin. Even if only the surface of the outlet passage cap is colored as above, according to the invention, the outlet passage cap has good appearance, so that an effect of concealing discoloration over time may be expected. In addition, even if a black dot is generated on a surface of or inside the outlet passage cap as a result of laser welding, the black dot is found with ease.

In the above-described embodiment, the example in which the laser light transmissive resin member is applied to the purge valve, and the internal space (chamber) as a volume chamber is formed between the laser light transmissive resin member and the laser light absorbing resin member, is illustrated. According to the invention, as another embodiment, the laser light transmissive resin member may also be applied to a resin molded product for whose internal space a high air-tightness is required such as a canister or an intake manifold. Additionally, the laser light transmissive resin member of the invention may be applied also to a resin molded product for whose internal space a high liquid-tightness is required, such as a product in which liquid is held by or circulated through an internal space.

In this manner, the invention is not limited to the above embodiments, and may be applied to various embodiments without departing from the scope of the invention.

Additional advantages and modifications will readily occur to those skilled in the art. The invention in its broader terms is therefore not limited to the specific details, representative apparatus, and illustrative examples shown and described.

What is claimed is:

1. A laser light transmissive resin member for laser-welding, comprising:
a laser welding portion which is adapted to be laser-welded to an external resin component, wherein:
the laser welding portion is colored so as to display such a color that satisfies the following relations:
V≦0.229H+3.714, V≦−0.8H+24, V≧3; and
C≦−0.075H²+1.936H+1.267, C≧2,
given that, in a Munsell color system:
V is value;
C is chroma; and
H is hue on condition that a hue circle is divided into 100 parts and one of 0 and 100 is assigned to 10 RP of hue; and
a transmission factor of the laser welding portion when the laser welding portion is irradiated with laser light having a wave length of 800 nm or greater, is equal to or larger than 15%.

2. The laser light transmissive resin member according to claim 1, wherein the laser light transmissive resin member is formed from polyamide series resin.

3. The laser light transmissive resin member according to claim 1, wherein thickness of the laser welding portion is equal to or smaller than 2.5 mm.

4. A resin molded product comprising:
the laser light transmissive resin member recited in claim 1; and
a laser light absorbing resin member including a laser absorbing portion which absorbs a laser light having a predetermined wave length that has passed through the laser welding portion so as to generate heat, the laser absorbing portion having a contact surface that is in contact with the laser welding portion of the laser light transmissive resin member, wherein the laser light absorbing resin member is welded to the laser light transmissive resin member at the contact surface as a result of the heat generation of the laser absorbing portion.

5. The resin molded product according to claim 4, wherein:
the laser light transmissive resin member is welded air-tightly or liquid-tightly onto the contact surface of the laser light absorbing resin member; and
the laser light transmissive resin member and the laser light absorbing resin member define a volume chamber having predetermined volume therebetween.
